(19) United States
(12) Patent Application Publication
(10) Pub. No.: US 2008/0091708 A1
(43) Pub. Date: Apr. 17, 2008

(54) Enhanced Detection of Search Engine Spam

(75) Inventor: Larry Thomas Caldwell, Annandale, VA (US)

Correspondence Address: FISH & RICHARDSON P.C., P.O. BOX 1022, MINNEAPOLIS, MN, 55440-1022, US

(73) Assignee: Idalis Software, Inc., Annandale, VA (US)

(21) Appl. No.: 11/871,539

(22) Filed: Oct. 12, 2007

Related U.S. Application Data
(60) Provisional application No. 60/829,672, filed on Oct. 16, 2006.

(51) Int. Cl. G06F 7/00

(52) U.S. Cl. 707/102

(57) ABSTRACT

The enhanced detection of search engine spam is provided in which an information resource is selected, the information resource including a plurality of block-level elements, each of the block-level elements are tokenized into attributes, and a first block-level element database is generated indexing the attributes of the first block-level element. Furthermore, the attributes indexed in the first block-level element database are iteratively compared with the attributes of each remaining block-level element, remaining block-level elements are flagged as suspect based on a threshold number of attributes of the remaining block-level elements being present in the first block-level element database, and the information resource is flagged as suspect based on a threshold percentage of the remaining block-level elements being flagged as suspect.

### CROSS-REFERENCE TO RELATED APPLICATION

This application claims the benefit of U.S. Provisional Patent Application No. 60/829,672, filed Oct. 16, 2006, which is incorporated herein by reference.

### FIELD

This document generally relates to the detection of search engine spam.

### BACKGROUND

Since the inception of networked computing, attempts have been made to solicit products or services to unwilling recipients via unsolicited electronic messages, where these unwarranted solicitations are euphemistically referred to as ‘spam.’ Although the most widely recognized form of spam is electronic mail spam, other forms have also gained notoriety, such as instant messaging spam (‘spim’), Usenet-newsgroup spam (‘sporgery’), search engine spam (‘spamdexing’), spam in blogs (‘splogs’), and mobile phone messaging spam (‘m-spam’).

With regard to spamdexing, search engines typically use software agents, or ‘bots,’ to crawl the Internet and index content obtained from web pages. Search engine providers rank the indexed content, and display ranked results upon receiving a query for specific keywords. Although many webmasters legitimately optimize their website content to obtain a higher search result ranking or PageRank for that content, web spammers have exploited inherent search engine characteristics by creating web pages replete with nonsensical content solely to increase page ranking, for the purpose raising revenue via ad placement or to farm links to a target web page.

Similarly, splogs are blog sites which are used for promoting affiliated web pages, which also exploit search engine ranking mechanisms in order to obtain ad impressions from visitors, or to use the blog as a link outlet to get new sites indexed. It is estimated that as many as one in five blogs on free blog hosts are splogs, where these fake blogs waste valuable disk space and bandwidth, and pollute search engine results. Furthermore, splogs effectively ruin blog search engines, and damaging bloggers community networking.

The proliferation of web spam has created an immense burden on search engine providers, which cannot automatically distinguish between legitimate, search engine-optimized web pages, and unsavory web pages created by spammers for revenue generation. Although web spam may be detected by manual human reporting, such reporting only occurs after the web page has already been indexed, and after bandwidth has already been expended. Furthermore, since thousands of spam web pages and splogs may be generated per minute, manual human reporting is no longer seen as a viable recourse to obviate the growing search engine spam problem.

### SUMMARY

Accordingly, the present disclosure provides for the enhanced detection of search engine spam without requiring manual human interaction, by subjecting information resources to scrutiny to determine correlations between block-level elements, and by comparing a quantification of block-element interrelatedness to a predefined threshold. In this regard, the determination of information resource legitimacy is automated, and is more comprehensive and accurate than manual human reporting.

According to one general implementation, an information resource is selected, the information resource including a plurality of block-level elements, each of the block-level elements are tokenized into attributes, and a first block-level element database is generated indexing the attributes of the first block-level element. Furthermore, the attributes indexed in the first block-level element database are iteratively compared with the attributes of each remaining block-level element, remaining block-level elements are flagged as suspect based on a threshold number of attributes of the remaining block-level elements being present in the first block-level element database, and the information resource is flagged as suspect based on a threshold percentage of the remaining block-level elements being flagged as suspect.

Implementations may include one or more of the following features. For example, the information resource may be a World Wide Web (“WWW”) page, identified by a unique Uniform Resource Locator (“URL”). The first block-level element may be a title, a paragraph, a heading, a list, a table, an image, an information resource name, or metadata, and the attribute may be a word or a phrase. Attributes may be deleted from the first block-level element. The first block-level element database may store each attribute of the first block-level element and an indicator of a frequency of occurrence of the each attribute in the first block-level element, where infrequently occurring attributes may be deleted from the first block-level element database. Links within the information resource may be flagged as suspect links, such as if uniform resource locators of two or more links point to a same target information resource.

According to another general implementation, an information resource is selected, the information resource including first through N^{th} block-level elements, each of the block-level elements are tokenized into attributes, and first and second block-level element databases are generated indexing the attributes of the first and second block-level elements, respectively. Furthermore, the attributes indexed in the first block-level element database are compared with the attributes of the second through the N^{th} block-level elements, the second through the N^{th} block-level element are flagged as suspect based on a threshold number of attributes the second through N^{th} block-level elements being present in the first block-level element database, and a first block-level element suspect percentage is stored based upon a percentage of the second through N^{th} block-level elements which are flagged as suspect. Additionally, the attributes indexed in the second block element database are compared with the attributes of the third through the N^{th} block-level elements, and the third through the N^{th} block-level element are flagged as suspect based on a threshold number of attributes of the third through N^{th} block-level elements being present in the second block-level element database. Moreover, a second block-level element suspect percentage is stored based on a percentage of the third through N^{th} block-level elements which are flagged as suspect, and the information resource is flagged as suspect based at least on the first and second block-level element suspect percentages and a threshold percentage. At least the first and second block-level element suspect percentages may be averaged.

According to another general implementation, a computer program product, tangibly stored on a computer-readable medium, includes instructions for permitting a computer to perform a selecting step for selecting an information resource, the information resource including a plurality of block-level elements, a tokenizing step for tokenizing each of the block-level elements into attributes, and a generating step for generating a first block-level element database indexing the attributes of the first block-level element. Furthermore, the computer program product also includes instructions for permitting the computer to perform a comparing step for iteratively comparing the attributes indexed in the first block-level element database with the attributes of each remaining block-level element, a first flagging step for flagging remaining block-level elements as suspect based on a threshold number of attributes of the remaining block-level elements being present in the first block-level element database, and a second flagging step for flagging the information resource as suspect based on a threshold percentage of the remaining block-level elements being flagged as suspect.

According to another general implementation, a computer program product, tangibly stored on a computer-readable medium, includes instructions for permitting a computer to perform a selecting step for selecting an information resource, the information resource including first through N^{th} block-level elements, a tokenizing step for tokenizing each of the block-level elements into attributes, and a generating step for generating first and second block-level element databases indexing the attributes of the first and second block-level elements, respectively. Additionally, the computer program product also includes instructions for permitting the computer to perform a first comparing step for comparing the attributes indexed in the first block-level element database with the attributes of the second through the N^{th} block-level elements, a first flagging step for flagging the second through the N^{th} block-level element as suspect based on a threshold number of attributes the second through N^{th} block-level elements being present in the first block-level element database, and a first storing step for storing a first block-level element suspect percentage based upon a percentage of the second through N^{th} block-level elements which are flagged as suspect. Additionally, the computer program product includes instructions for permitting the computer to perform a second comparing step for comparing the attributes indexed in the second block element database with the attributes of the third through the N^{th} block-level elements, and a second flagging step for flagging the third through the N^{th} block-level element as suspect based on a threshold number of attributes of the third through N^{th} block-level elements being present in the second block-level element database. Moreover, the computer program product also includes instructions for permitting the computer to perform a second storing step for storing a second block-level element suspect percentage based on a percentage of the third through N^{th} block-level elements which are flagged as suspect, and a third flagging step for flagging the information resource as suspect based at least on the first and second block-level element suspect percentages and a threshold percentage.

According to another general implementation, a device includes a selecting module, a processor, and an output module. The selecting module selects an information resource, the information resource including a plurality of block-level elements. The processor tokenizes each of the block-level elements into attributes, generates a first block-level element database indexing the attributes of the first block-level element, iteratively compares the attributes indexed in the first block-level element database with the attributes of each remaining block-level element, flags remaining block-level elements as suspect based on a threshold number of attributes of the remaining block-level elements being present in the first block-level element database, and flags the information resource as suspect based on a threshold percentage of the remaining block-level elements being flagged as suspect. The output module outputs the information resource based upon the information resource being flagged as suspect.

According to another general implementation, a device includes a selecting module, a processor, a memory medium, and an output module. The selecting module selects an information resource, the information resource including first through N^{th} block-level elements. The processor tokenizes each of the block-level elements into attributes, generates first and second block-level element databases indexing the attributes of the first and second block-level elements, respectively, and compares the attributes indexed in the first block-level element database with the attributes of the second through the N^{th} block-level elements. The processor further flags the second through the N^{th} block-level element as suspect based on a threshold number of attributes the second through N^{th} block-level elements being present in the first block-level element database, compares the attributes indexed in the second block element database with the attributes of the third through the N^{th} block-level elements, flags the third through the N^{th} block-level element as suspect based on a threshold number of attributes of the third through N^{th} block-level elements being present in the second block-level element database, and flags the information resource as suspect based at least on the first and second block-level element suspect percentages and a threshold percentage. The memory medium stores a first block-level element suspect percentage based upon a percentage of the second through N^{th} block-level elements which are flagged as suspect, and stores a second block-level element suspect percentage based on a percentage of the third through N^{th} block-level elements which are flagged as suspect. The output module outputs the information resource based upon the information resource being flagged as suspect.

The details of one or more implementations are set forth in the accompanying drawings and the description below. Other potential features and advantages will be apparent from the description and drawings, and from the claims.

### DESCRIPTION OF DRAWINGS

FIG. 1 depicts the exterior of an exemplary system.

FIG. 2 depicts an exemplary internal architecture of the computer depicted in FIG. 1.

FIGS. 3 and 4 are flowcharts illustrating exemplary processes.

FIG. 5 illustrates an exemplary splog.

FIG. 6 depicts a process for detecting a web spam farm.

Like reference number represent corresponding part throughout.

### DETAILED DESCRIPTION

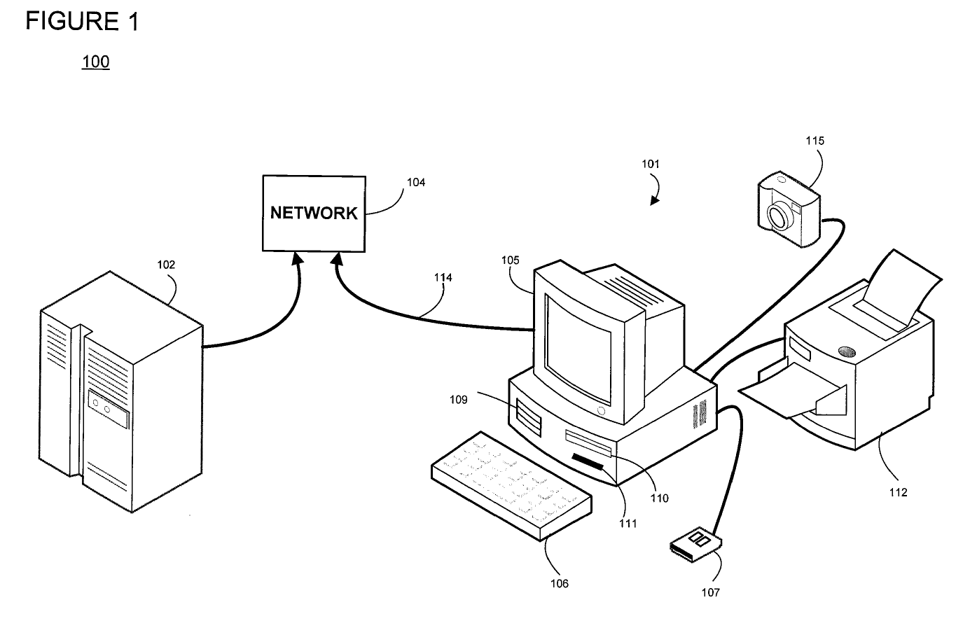

FIG. 1 depicts the exterior appearance of an example system 100, including a computer 101 and a server 102 connected via a network 104. The hardware environment of the computer 101 includes a display monitor 105 for displaying text and images to a user, a keyboard 106 for entering text data and user commands into the computer 101, a mouse 107 for pointing, selecting and manipulating objects displayed on the display monitor 105, a fixed disk drive 109, a removable disk drive 110, a tape drive 111, a hardcopy output device 112, a computer network connection 114, and a digital input device 115.

The display monitor 105 displays the graphics, images, and text that comprise the user interface for the software applications used by the computer 101, as well as the operating system programs necessary to operate the computer 101. A user uses the keyboard 106 to enter commands and data to operate and control the computer operating system programs as well as the application programs. The user uses the mouse 107 to select and manipulate graphics and text objects displayed on the display monitor 105 as part of the interaction with and control of the computer 101 and applications running on the computer 101. The mouse 107 may be any type of pointing device, and such as a joystick, a trackball, a touch-pad, or other pointing device. Furthermore, the digital input device 115 allows the computer 101 to capture digital images, and may be a scanner, a digital camera, a digital video camera, or other digital input device. Software used to provide for the detection of web spam is stored locally on computer readable memory media, such as the fixed disk drive 109.

In a further implementation, the fixed disk drive 109 itself may include a number of physical drive units, such as a redundant array of independent disks (“RAID”), or may be a disk drive farm or a disk array that is physically located in a separate computing unit. Such computer readable memory media allow the computer 101 to access computer-executable process steps, application programs and the like, stored on removable and non-removable memory media.

The computer network connection 114 may be a modem connection, a local-area network (“LAN”) connection including the Ethernet, or a broadband wide-area network (“WAN”) connection such as a digital subscriber line (“DSL”), cable high-speed internet connection, dial-up connection, T-1 line, T-3 line, fiber optic connection, or satellite connection. The network 104 may be a LAN network, a corporate or government WAN network, the Internet, or other network.

The computer network connection 114 may be a wireline or wireless connector. Example wireless connectors include, for example, an INFRARED DATA ASSOCIATION® (“IrDA®”) wireless connector, an optical wireless connector, an INSTITUTE OF ELECTRICAL AND ELECTRONICS ENGINEERS® (“IEEE®”) Standard 802.11 wireless connector, a BLUETOOTH® wireless connector, an orthogonal frequency division multiplexing (“OFDM”) ultra wide band (“UWB”) wireless connector, a time-modulated ultra wide band (“TM-UWB”) wireless connector, or other wireless connector. Example wireline connectors include, for example, a IEEE®-1394 FIREWIRE® connector, a Universal Serial Bus (“USB”) connector, a serial port connector, a parallel port connector, or other wired connector.

The removable disk drive 110 is a removable storage device that is used to off-load data from the computer 101 or upload data onto the computer 101. The removable disk drive 110 may be a floppy disk drive, an IOMEGA® ZIP® drive, a compact disk-read only memory (“CD-ROM”) drive, a CD-Recordable drive (“CD-R”), a CD-Rewritable drive (“CD-RW”), flash memory, a USB flash drive, thumb drive, pen drive, key drive, a High-Density Digital Versatile Disc (“HD-DVD”) optical disc drive, a Blu-Ray optical disc drive, a Holographic Digital Data Storage (“HDDS”) optical disc drive, or any one of the various recordable or rewritable digital versatile disc (“DVD”) drives such as the DVD-Recordable (“DVD-R” or “DVD+R”), DVD-Rewritable (“DVD-RW” or “DVD+RW”), or DVD-RAM. Operating system programs, applications, and various data files, are stored on disks, which are stored on the fixed disk drive 109 or on removable media for the removable disk drive 110.

The tape drive 111 is a tape storage device that is used to off-load data from the computer 101 or to upload data onto the computer 101. The tape drive 111 may be a quarter-inch cartridge (“QIC”), 4 mm digital audio tape (“DAT”), 8 mm digital linear tape (“DLT”) drive, or other type of tape.

The hardcopy output device 112 provides an output function for the operating system programs and applications. The hardcopy output device 112 may be a printer or any output device that produces tangible output objects, including textual or image data or graphical representations of textual or image data. While the hardcopy output device 112 is depicted as being directly connected to the computer 101, it need not be. For instance, the hardcopy output device 112 may be connected to computer 101 via a network interface, such as a wireline or wireless network.

The server 102 exists remotely via network 104, and includes one or more networked data server devices or servers. The server 102 acts as a repository for information resources, such as web pages, and services requests for information resources sent by the computer 101. where the server 102 may include a server farm, a storage farm, or a storage server.

Although the computer 101 is illustrated in FIG. 1 as a desktop PC, in further implementations the computer 101 may be a laptop, a workstation, a midrange computer, a mainframe, an embedded system, telephone, a handheld or tablet computer, a PDA, or other type of computer.

Although further description of the components which make up the server 102 is omitted for the sake of brevity, it suffices to say that the hardware environment of the computer or individual networked computers which make up the server 102 is similar to that of the exemplary hardware environment described herein with regard to the computer 101. In an alternate implementation, the functions of the computer 101 and the server 102 are combined in a single, hardware environment.

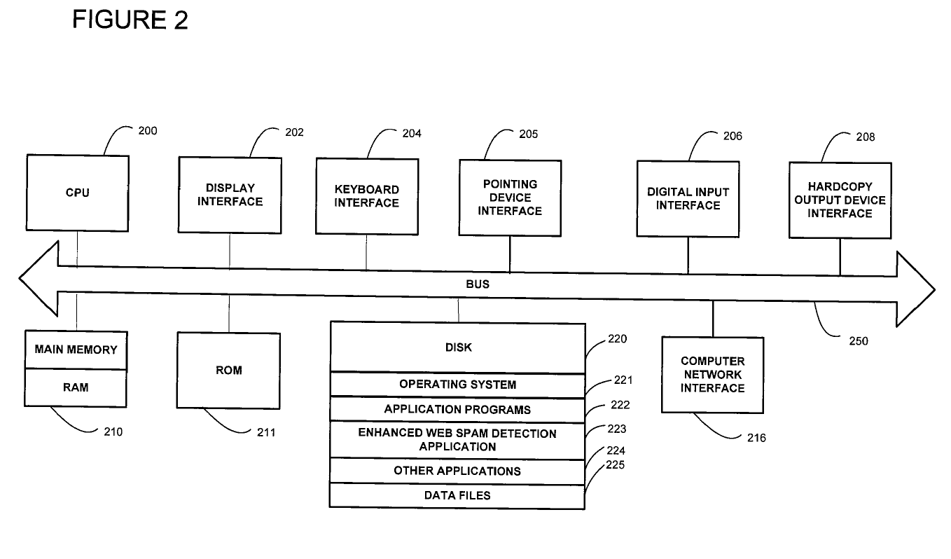

FIG. 2 depicts an example of an internal architecture of the computer 101. The computing environment includes a computer central processing unit (“CPU”) 200 where the computer instructions that comprise an operating system or an application are processed; a display interface 202 which provides a communication interface and processing functions for rendering graphics, images, and texts on the display monitor 105; a keyboard interface 204 which provides a communication interface to the keyboard 106; a pointing device interface 205 which provides a communication interface to the mouse 107 or an equivalent pointing device; a digital input interface 206 which provides a communication interface to the digital input device 115; a hardcopy output device interface 208 which provides a communication interface to the hardcopy output device 112; a random access memory (“RAM”) 210 where computer instructions and data are stored in a volatile memory device for processing by the computer CPU 200; a read-only memory (“ROM”) 211 where invariant low-level systems code or data for basic system functions such as basic input and output (“I/O”), startup, or reception of keystrokes from the keyboard 106 are stored in a non-volatile memory device; and optionally a storage 220 or other suitable type of memory (e.g. such as random-access memory (“RAM”), read-only memory (“ROM”), programmable read-only memory (“PROM”), erasable programmable read-only memory (“EPROM”), electrically erasable programmable read-only memory (“EEPROM”), magnetic disks, optical disks, floppy disks, hard disks, removable cartridges, flash drives), where the files that comprise an operating system 221, application programs 222 (including enhanced web spam detection application 223, and other applications 224 as necessary) and data files 225 are stored; a computer network interface 216 which provides a communication interface to the network 104 over the computer network connection 114. The constituent devices and the computer CPU 200 communicate with each other over the computer bus 250.

The RAM 210 interfaces with the computer bus 250 so as to provide quick RAM storage to the computer CPU 200 during the execution of software programs such as the operating system application programs, and device drivers. More specifically, the computer CPU 200 loads computer-executable process steps from the fixed disk drive 109 or other memory media into a field of the RAM 210 in order to execute software programs. Data is stored in the RAM 210, where the data is accessed by the computer CPU 200 during execution.

Also shown in FIG. 2, the computer 101 stores computer-executable code for a operating system 221, application programs 222 such as word processing, spreadsheet, presentation, gaming, or other applications. Although it is possible to provide for the enhanced detection of search engine spam using the above-described implementation, it is also possible to implement the functions according to the present disclosure as a dynamic link library (“DLL”), or as a plug-in to other application programs such as an Internet web-browser such as the MICROSOFT® Internet Explorer web browser.

The computer CPU 200 is one of a number of high-performance computer processors, including an INTEL® or AMD® processor, a POWERPC® processor, a MIPS® reduced instruction set computer (“RISC”) processor, a SPARC® processor, an ACORN RISC Machine (“ARM®”) architecture processor, a HP ALPHASERVER® processor or a proprietary computer processor for a mainframe. In an additional arrangement, the computer CPU 200 is more than one processing unit, including a multiple CPU configuration found in high-performance workstations and servers, or a multiple scalable processing unit found in mainframes.

The operating system 221 may be MICROSOFT® WINDOWS NT®/WINDOWS® 2000/WINDOWS® XP Workstation; WINDOWS NT®/WINDOWS® 2000/WINDOWS® XP Server; a variety of UNIX®-flavored operating systems, including AIX® for IBM® workstations and servers, SUNOS® for SUN® workstations and servers, LINUX® for INTEL® CPU-based workstations and servers, HP UX WORKLOAD MANAGER® for HP® workstations and servers, IRIX® for SGI® workstations and servers, VAX/VMS for Digital Equipment Corporation computers, OPENVMS® for HP ALPHASERVER®-based computers, MAC OS® X for POWERPC® based workstations and servers; SYMBIAN OS®, WINDOWS MOBILE® or WINDOWS CE®, PALM®, NOKIA® OS (“NOS”), OSE®, or EPOC® for mobile devices, or a proprietary operating system for computers or embedded systems. The application development platform or framework for the operating system 221 may be: BINARY RUNTIME ENVIRONMENT FOR WIRELESS® (“BREW®”); Java Platform, Micro Edition (“Java ME”) or Java 2 Platform, Micro Edition (“J2ME®”); PYTHON™, FLASH LITE®, or MICROSOFT® .NET Compact.

Although further description of the internal architecture of the server 102 is omitted for the sake of brevity, it suffices to say that the architecture is similar to that of the computer 101. In an alternate implementation, where the functions of the computer 101 and the server 102 are combined in a single, combined hardware environment, the internal architecture is combined or duplicated.

According to one general implementation, the enhanced web spam detection application 223 selects an information resource, the information resource including a plurality of block-level elements. The CPU 200 tokenizes each of the block-level elements into attributes, generates a first block-level element database indexing the attributes of the first block-level element, iteratively compares the attributes indexed in the first block-level element database with the attributes of each remaining block-level element, flags remaining block-level elements as suspect based on a threshold number of attributes of the remaining block-level elements being present in the first block-level element database, and flags the information resource as suspect based on a threshold percentage of the remaining block-level elements being flagged as suspect. The display interface 202 outputs the information resource based upon the information resource being flagged as suspect.

According to another general implementation, the enhanced web spam detection application 223 selects an information resource, the information resource including first through N^{th} block-level elements. The CPU 200 tokenizes each of the block-level elements into attributes, generates first and second block-level element databases indexing the attributes of the first and second block-level elements, respectively, and compares the attributes indexed in the first block-level element database with the attributes of the second through the N^{th} block-level elements. The CPU 200 flags the second through the N^{th} block-level element as suspect based on a threshold number of attributes the second through N^{th} block-level elements being present in the first block-level element database, compares the attributes indexed in the second block element database with the attributes of the third through the N^{th} block-level elements, flags the third through the N^{th} block-level element as suspect based on a threshold number of attributes of the third through N^{th} block-level elements being present in the second block-level element database, and flags the information resource as suspect based at least on the first and second block-level element suspect percentages and a threshold percentage. The main memory 200 stores a first block-level element suspect percentage based upon a percentage of the second through N^{th} block-level elements which are flagged as suspect, and stores a second block-level element suspect percentage based on a percentage of the third through N^{th} block-level elements which are flagged as suspect. The display interface 202 output the information resource based upon the information resource being flagged as suspect.

While FIGS. 1 and 2 illustrate one possible implementation of a computing system that executes program code, or program or process steps, configured to effectuate the detection of web spam, other types of computers may also be used as well.

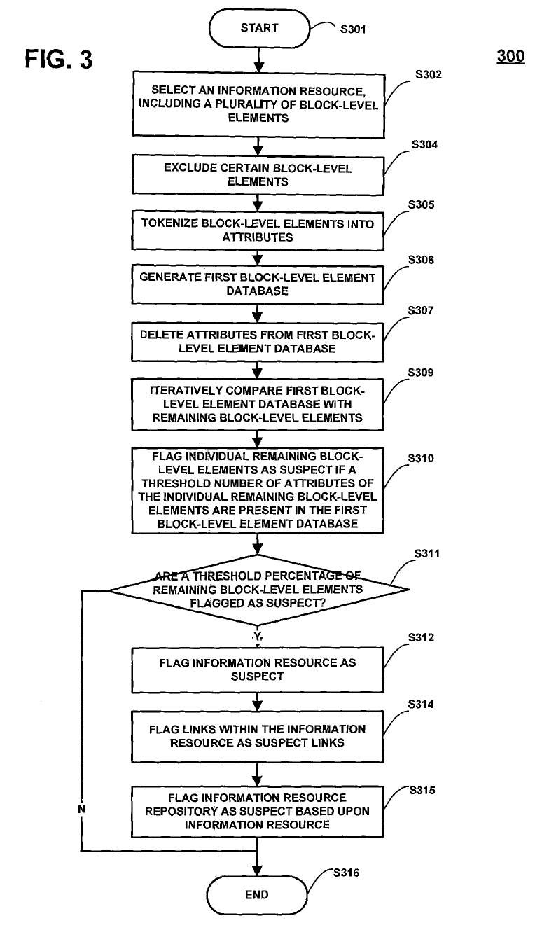

FIG. 3 is a flowchart illustrating an exemplary process 300. Briefly, an information resource is selected, the information resource including a plurality of block-level elements, each of the block-level elements are tokenized into attributes, and a first block-level element database is generated indexing the attributes of the first block-level element. Furthermore, the attributes indexed in the first block-level element database are iteratively compared with the attributes of each remaining block-level element, remaining block-level elements are flagged as suspect based on a threshold number of attributes of the remaining block-level elements being present in the first block-level element database, and the information resource is flagged as suspect based on a threshold percentage of the remaining block-level elements being flagged as suspect.

In more detail, the process 300 begins (S301), and an information resource is selected, the information resource including a plurality of block-level elements (S302). The information resource may be a World Wide Web (“WWW”) page, identified by a unique Uniform Resource Locator (“URL”). Alternatively, the information resource may be any durable piece of arbitrary information or resource for storing information that is available to a computer program, or a referent of any Internationalized Resource Identifier (“IRI”). Example information resources include an electronic document, an image, a service, or a collection of other resources.

Each information resource includes a plurality of block-level elements. Block-level elements, such as the page name, the information resource file name, title, metadata, headings, paragraphs, lists, or tables, are large structures containing other blocks, inline elements, or text, and are usually displayed as independent blocks separated from other blocks by vertical space or margins. Notably, block-level elements are distinguishable from inline or text-level elements, such as hyperlinks, citations, or quotations, which are smaller structures that represent or describe small pieces of text or data.

Inline or text-level elements often contain only text or other inline elements, and are usually displayed one after another on a line within the block that contains them. Some block-level elements, such as paragraphs contain only inline elements. Furthermore, although some block-level elements such as forms or lists include block-level child elements, most block-level elements include either block-level or inline elements. The first block-level element may be a title, a paragraph, a heading, a list, a table, an image, an information resource name, or metadata.

A information resource may be selected when a web page is chosen from a list of suspicious web pages. For example, and as described in further detail below, when a particular information resource is flagged as being a suspect information resource, certain out-links on that information resource are added to the list of suspicious web pages. In this regard, each out-link is subsequently selected in an iterative and recursive process. Information resources may also be selected in other manners, such as randomly, by following links pointing to suspicious web pages, via human interaction, by following incoming or outgoing links associated with legitimate information resources, or by using advanced algorithms or heuristical models. In one example, the computer 101 selects an information resource by transmitting a request for an information resource stored on server 102 via network 104, where server 102 responds to the request by transmitting a copy of the information resource to the computer via network 104.

Upon identifying the plurality of block-level elements associated with a selected information resource, such as by reading metadata tags, certain block-level elements may be ignored or excluded from scrutiny (S304). For example, many web pages include a banner ad block-level element which can safely be ignored, where excluded block-level elements are stored in an exclusion database which is compared against the information resource. By ignoring certain excluded block-level elements, the processing of each information resource may occur more quickly, fewer system resources are used, and the accuracy of the overall legitimacy determination is increased.

Each of the block-level elements are tokenized into attributes (S305), where tokenizing refers to the process of demarcating sections of a string of input characters for further processing. The attribute may be a string of characters, word, a phrase, a sentence, a paragraph, or any other parseable section. Each block-level element, with the possible exception of those block-level elements which are excluded from scrutiny, is tokenized into attributes.

At least a first block-level element database is generated, where the first block-level element database indexes the attributes of the first block-level element (S306). In a further implementation, for each block-level element which is not excluded from scrutiny, an attribute database is generated which stores each attribute, although certain attributes may also be excluded from scrutiny or further examination. The attributes stored in the block-level element database associated with the first block-level element are compared against the attributes of a subset of the block-level elements associated with the information resource.

For example, if an information resource includes ten block-level elements, the attributes stored in the block-level element database associated with the first block-level element may be compared against all ten block-level elements, the second through tenth or ‘remaining’ block-level elements, the second block-level element alone, the second, fifth, seventh and eighth block, level elements, or any combination of block-level elements. Furthermore, if the information resource includes ten block-level elements, where the third, fifth and eighth block-level elements are excluded, the attributes stored in the block-level element database associated with the first-block-level element may or may not be compared against the third, fifth and/or eighth block-level elements, depending upon system configuration, and desired speed and accuracy parameters.

Attributes may be deleted from the first block-level element database (S307). According to one implementation, the determination of legitimacy of an information resource is highly correlated to the finding of similar verbs, nouns, product names or brands between different block-level elements, certain attributes, such as times, dates, pronoun, prepositions, conjunctions, interjections and adjectives, may also be ignored or excluded from scrutiny. For example, many web pages may include the adjectives “a,” “an” or “the.” The exclusion database may store a list of excluded attributes, and compare this list against each block-level element or block-level element database before subjecting the block-level element to additional scrutiny or examination.

In another implementation, the exclusion database stores a list of domains or Uniform Resource Locators (URLs), or the exclusion database is a remotely-located and maintained list of domains or URLS, such as GOOGLE®'s TRUSTRANK list of sites, which compiles and approves sites which are unlikely to be prone to unethical search engine optimization tactics or click fraud.

The first block-level element database may store each attribute of the first block-level element and an indicator of a frequency of occurrence of the each attribute in the first block-level element, where infrequently occurring attributes may be deleted from the first block-level element database. In one implementation, the block-level element database is generated, and attributes stored are ranked based upon the number of instances that each attribute occurs in the respective block-level element. Further, attributes which a small number of instances, such as those attributes mentioned only once, twice, or ten times in each respective block-level element, are deleted from the block-level element database. By reducing the number of attributes stored in each block-level element database, processing of each information resource may occur more quickly, with scrutiny directed towards those attributes which are repeated most frequently throughout the information resource as a whole.

The attributes indexed in the first block-level element database are iteratively compared with the attributes of each remaining block-level element (S309). In the above example, using a recursive technique, attributes associated with the second and third block-level elements are compared against the first block-level element database, and the attributes associated with the third block-level element are compared against the second block-level element database. Using a cascading technique, attributes associated with the second and third block-level elements are compared against the first block-level element database, the attributes associated with the first and third block-level elements are compared against the second block-level element database, and the attributes associated with the first and second block-level elements are compared against the third block-level element database.

Remaining block-level elements are flagged as suspect based on a threshold number of attributes of the remaining block-level elements being present in the first block-level element database (S310). An information resource with more suspect block-level elements has a greater probability of itself being suspect or illegitimate than an information resource with few or no suspect block-level elements.

If a threshold number of attributes of the other block-level elements are present in the first block-level element database, that particular other block-level element is flagged as suspect. An example information resource may includes three block-level elements, where the threshold number is five. If four attributes of the second block-level element are present in the first block-level element database, and seven attributes of the third block-level element are present in the first block-level element database, the third block-level element alone would be flagged as suspect.

The threshold number of attributes is a user-configurable or automatically-configured number and is any number greater than or equal to one. In various implementations, for example, the threshold number is 1, 1.1, 2, 3, 5, 8, 10, 16, 23, 50, 100, 500, 1000, 10,000, or greater. The threshold number may be automatically determined, for example, based upon the block-element databases which are generated for each block-element. For example if the smallest block-element database stores ten non-excluded attributes, the threshold number may be automatically set as ten or less.

The information resource is flagged as suspect based on a threshold percentage of the remaining block-level elements being flagged as suspect. In particular, if a threshold percentage of the block-level elements under scrutiny are flagged as suspect (S311), the information resource is flagged as suspect (S312). If a threshold percentage of the block-level elements are not flagged as suspect (S311), the information is not flagged as suspect.

In the above example, for the first block-level element, 50% of the block-level elements under scrutiny were flagged as suspect. In the recursive example, if 33% of the block-level elements under scrutiny for the second block-level element were flagged as suspect, the average percentage of block-level elements flagged as suspect is (50%+33%)÷2=42%. Thus, if the threshold percentage was less than 42%, the information resource would also be flagged as suspect. The threshold percentage is a user-configurable or automatically-configured percentage and is any number greater than zero. In various implementations, for example, the threshold percentage is 0.01%, 0.5%, 2%, 5%, 8%, 10%, 16%, 23%, 50%, 99%, 100%, or any other percentage.

If the information resource is flagged as suspect (S312), links associated with the information resource, or ‘out-links,’ may also be flagged as suspect links (S314). Flagging refers to an identifying or indicating process, such as a process which stores an identified data item in a particular list, array or database, or outputs or transmits the data item or an indication of the data item.

Based upon this examination, the information resource is denoted as suspect or legitimate. In a similar manner, where the information resource is a web page, each information resource on a particular server may be examined and the entire information resource repository or server may also be denoted as suspect if a threshold percentage of information resources residing on the server are denoted as suspect (S315), thereby ending process 300 (S316). Moreover, if the threshold percentage of remaining block-level elements is not flagged as suspect (S315), the information resource repository may still be flagged as suspect based upon another threshold percentage of the information resources residing on the information resource repository being denoted as suspect (S315).

In order to achieve a higher ranking or relevancy, web spam must be set up or arranged to include identifiable, predisposed conditions. Since search engine keywords are often product names or descriptions, these types of words are often used repeatedly in web spam. Accordingly, when each block-level element is parsed and analyzed, a legitimacy threshold can be established from the content of the web page.

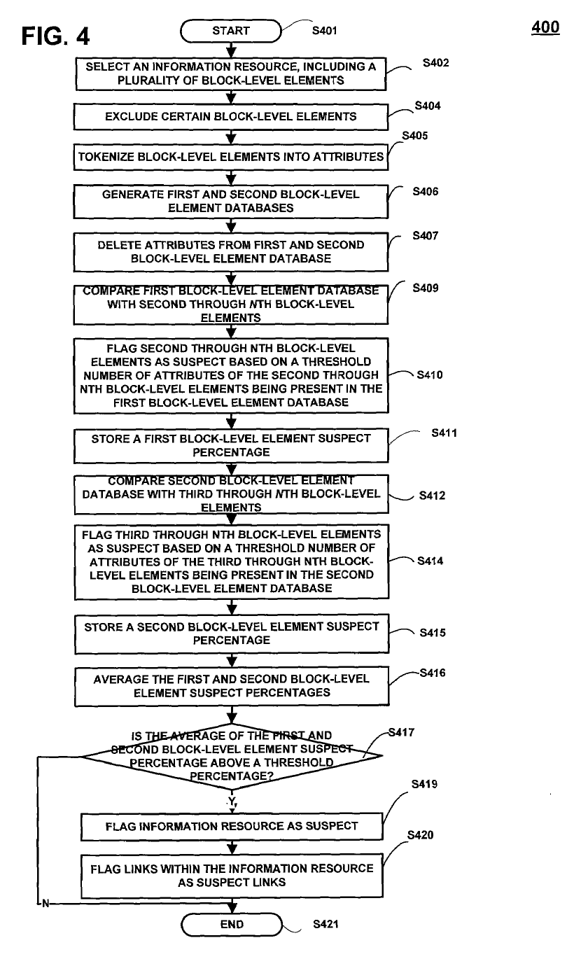

FIG. 4 is a flowchart illustrating an exemplary process 400. Briefly, an information resource is selected, the information resource including first through N^{th} block-level elements, each of the block-level elements are tokenized into attributes, and first and second block-level element databases are generated indexing the attributes of the first and second block-level elements, respectively. Furthermore, the attributes indexed in the first block-level element database are compared with the attributes of the second through the N^{th} block-level elements, the second through the N^{th} block-level element are flagged as suspect based on a threshold number of attributes the second through N^{th} block-level elements being present in the first block-level element database, and a first block-level element suspect percentage is stored based upon a percentage of the second through N^{th} block-level elements which are flagged as suspect. Additionally, the attributes indexed in the second block element database are compared with the attributes of the third through the N^{th} block-level elements, and the third through the N^{th} block-level element are flagged as suspect based on a threshold number of attributes of the third through N^{th} block-level elements being present in the second block-level element database. Moreover, a second block-level element suspect percentage is stored based on a percentage of the third through N^{th} block-level elements which are flagged as suspect, and the information resource is flagged as suspect based at least on the first and second block-level element suspect percentages and a threshold percentage. At least the first and second block-level element suspect percentages may be averaged.

In more detail, the process 400 begins (S401), and an information resource is selected, the information resource including first through N^{th} block-level elements, where N represents any real number greater than 1.

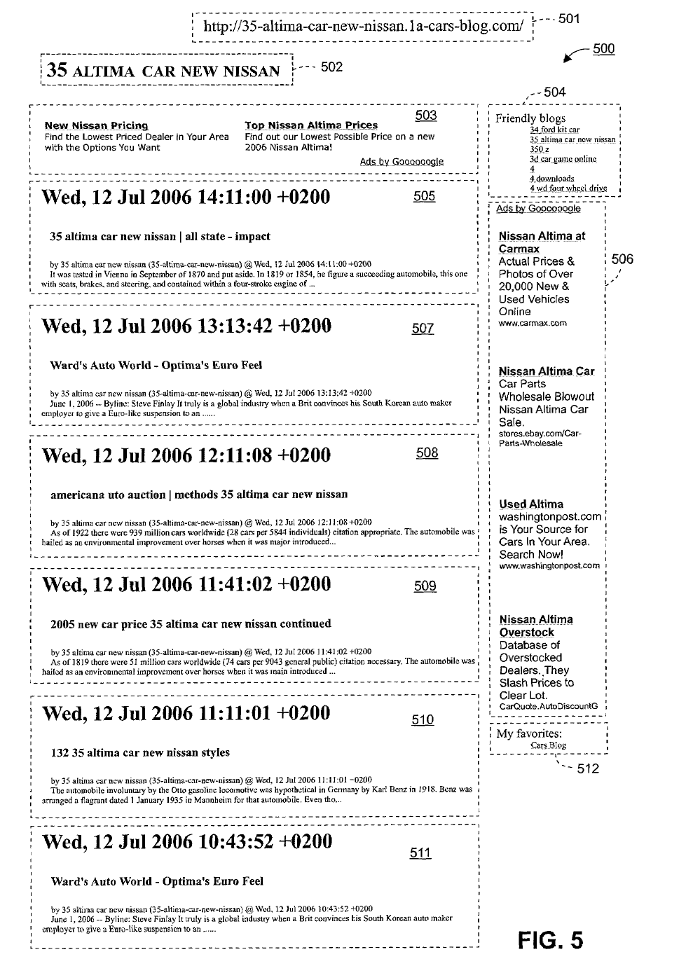

Referring ahead briefly, FIG. 5 illustrates an exemplary splog 500. A web spammer creates an information resource, such as spam web site or splog, and manually or automatically updates the content to build the relevancy of the information resource. In this example, the splog includes multiple block-level elements including the terms “car,” “Nissan” and “Altima,” and permutations thereof. By repeating these terms and related terms, such as “engine,” “seat,” and “new,” the relevancy of the web page increases for larger terms, such as “new Nissan Altima,” or “Nissan Altima car.” Although the number of terms included on the web page must also increase in order to build relevancy, certain static characteristics, such as the terms “car,” “Nissan” and “Altima,” stay the same throughout the entire web page.

Upon cursory review, it is clear that the weblog illustrated in FIG. 5 is a splog. For example, the terms “car,” “Nissan” and “Altima” are repeated throughout each block-level element, and the remaining inline text elements surrounding the repeated terms are nonsensical. Splog 500 includes block-level elements 501 to 512, of which block-level element 501 is the URL, block-level element 502 is the title, block-level element 503 and 506 are banner ads originated at trusted sites, and block-level elements 504, 505, and 507 to 512 are separate paragraphs.

Certain of the block-level elements may be excluded from further scrutiny (S404). In splog 500, for example, banner ad block-level elements 503 and 506 may be ignored. An exclusion database may store a list of harmless block-level element types, or block-level element identifiers which are to be ignored, where the exclusion database is compared against the information resource prior to tokenizing the block-level elements. Since certain block-level elements are ignored, information resource is processed more quickly, requiring fewer system resources, and increasing the overall the accuracy of a legitimacy determination.

Each of the block-level elements are tokenized into attributes, by demarcating a string of input characters into sections (S405), where each attributes may be a word or a phrase. For example, URL block-level element 501 may be tokenized into the words “new,” “car,” “Altima,” and “Nissan,” into the phrases “new car” and “Nissan Altima,” or into another combination of words and/or phrases. To increase processing efficiency and accuracy, block-level elements which are excluded from scrutiny (S404) may not by tokenized.

At least first and second block-level element databases are generated indexing the attributes of the first and second block-level elements, respectively (S406). In the case where more than two block-level elements are subject to scrutiny, or are not excluded, additional block-level element databases may also be generated for each block-level element. As described more fully above, certain attributes from the first and second block-level element databases may be deleted (S407).

Attributes may be deleted based upon accessing an exclusion database which stores a list of trusted domains or Uniform Resource Locators (URLs). For example, the exclusion database may be a local, proprietary exclusion database, or a remotely-located and maintained list of domains or URLS, such as GOOGLE®'s TRUSTRANK list of sites.

Table 1 illustrates an exemplary block-level element database corresponding to URL block-level element 501, Table 2 illustrates an exemplary block-level element database corresponding to title block-level element 502, and Tables 3 and 4 illustrate exemplary block-level element databases corresponding to paragraph block-level elements 504 and 505. Since banner ad block-level element 503 was excluded from scrutiny (S404), no block-level element database was generated for that block-level element, although in other implementations a block-level element database may be generated for those block-level elements which are excluded from scrutiny.

TABLE 1

| | |
|---|---|
| ALTIMA | 1 |
| CAR | 2 |
| NEW | 1 |
| NISSAN | 1 |
| BLOG | 1 |

TABLE 2

| | |
|---|---|
| ALTIMA | 1 |
| CAR | 1 |
| NEW | 1 |
| NISSAN | 1 |

TABLE 3

| | |
|---|---|
| FRIENDLY | 1 |
| BLOG | 1 |
| FORD | 1 |
| KIT | 1 |
| CAR | 3 |
| ALTIMA | 1 |
| NEW | 1 |
| NISSAN | 1 |
| GAME | 1 |
| ONLINE | 1 |
| DOWNLOAD | 1 |
| FOUR WHEEL DRIVE | 1 |

TABLE 4

| | |
|---|---|
| ALTIMA | 3 |
| CAR | 3 |
| NEW | 3 |
| NISSAN | 3 |
| TESTED | 1 |
| VIENNA | 1 |
| FIGURE | 1 |
| SUCCEEDING | 1 |
| AUTOMOBILE | 1 |
| SEATS | 1 |
| BRAKES | 1 |
| STEERING | 1 |
| FOUR-STROKE | 1 |
| ENGINE | 1 |

Table 1, corresponding to URL block-level element 501, includes the terms “Altima,” “car,” “new” “Nissan,” and “blog,” which were tokenized from the URL “http://35-Altima-car-new-Nissan.1a-cars-blog.com/.” Certain attributes, such as punctuation, numbers, and the terms “http” and “1a” have been ignored as excluded attributes, and the plural word “cars” has been tokenized into the singular word “car.” As indicated above, other tokenization techniques are also possible. Although Tables 2 to 4 have been tokenized in a similar manner, the terms “four wheel drive” and “four stroke” have been tokenized into recognized term tokens instead of single word tokens.

The attributes indexed in the first block-level element database are compared with the attributes of the second through the N^{th} block-level elements (S409). In the above example, the attributes “Altima,” “new,” “Nissan,” “car,” and “blog,” are compared against block-level elements 504, 505, and 507 to 511. The title block-level element 502 and the paragraph block-level element 505, for example, each include four of five of the attributes (“Altima,” “new,” “Nissan,” and “car”).

Table 5 illustrates the partial result of the comparison between the block-level element database for block-level element 501 and the attributes of block-level elements 501 to 506. The first column indicated the block-level element that the block-level element database is compared against, and the second column indicated the number of attributes of the compared block-element which exist in the block-element database. The number of instances is indicated as “(same)” where the block-element database is compared against its own block-element, and the number of instances is indicated as “(excluded)” where the block-element is excluded, and thus not compared against the block-element database.

TABLE 5

| | |
|---|---|
| Block Element 501 | (same) |
| Block Element 502 | 4 |
| Block Element 503 | (excluded) |
| Block Element 504 | 5 |
| Block Element 505 | 4 |
| Block Element 506 | (excluded) |
| . . . | |

The second through the N^{th} block-level element are flagged as suspect based on a threshold number of attributes the second through N^{th} block-level elements being present in the first block-level element database (S410). In the above example, if the threshold number was four, then block-level elements 502, 504 and 505 would be flagged as suspect, since block-level element 502 and 505 both included four of the attributes associated with block-level element 501 and block-level element 505 includes all five of the attributes associated with block-level element 501. If the threshold number was set at five, then neither block-level elements 502 and 505 would be flagged as suspect, however block-level element 504 would be flagged as suspect. If the threshold number was set at six or more, than none of block-level elements 502, 504 and 505 would be flagged as suspect.

A first block-level element suspect percentage is stored based upon a percentage of the second through N^{th} block-level elements which are flagged as suspect (S411). In the above example, if the threshold number was four, the block-level element suspect percentage for block-level element 501 is 89%, since each of the block-level elements except for block-level element 512 include four attributes (“Altima,” “car,” “new,” and “Nissan”) in common with the URL block-level element 501. If the threshold number was set as five or more, the block-level element suspect percentage for block-level element 501 is 0%, since none of the other block-level elements also include the word “blog.” Since block-level elements 503 and 506 represent banner ads, they are excluded from scrutiny.

The attributes indexed in the second block element database are compared with the attributes of the third through the N^{th} block-level elements (S412). In the above-example, the four attributes of the title block-level element 502 (“Altima,” “car,” “new,” and “Nissan”) are compared with the attributes of block-level elements 504 and 505 to 512. In a cascading example, the attributes of the title block-level element 502 would also be compared with the attributes of block-level element 501 as well.

Table 6 illustrates the partial result of the comparison between the block-level element database for block-level element 502 and the attributes of block-level elements 502 to 506. Although, using a recursive approach, a block-level element database is not compared to a previous block-level, in a cascading approach the block-level element database would be compared to a previous block-level element. For example, using the recursive approach the attributes of the block-level element database for the second block-level would not be compared to the first block-level element, while the cascading approach would make such a comparison. Table 6 illustrates the partial results for a recursive approach.

TABLE 6

| | |
|---|---|
| Block Element 2 | (same) |
| Block Element 3 | (excluded) |
| Block Element 4 | 4 |
| Block Element 5 | (excluded) |
| Block Element 6 | 4 |
| . . . | |

The third through the N^{th} block-level element are flagged as suspect based on a threshold number of attributes of the third through N^{th} block-level elements being present in the second block-level element database (S414). A second block-level element suspect percentage is stored based on a percentage of the third through N^{th} block-level elements which are flagged as suspect (S415). In the above example, the block-level element suspect percentage for block-level element 502 is also 89%.

At least the first and second block-level element suspect percentages may be averaged (S416). If the first and second block-level element suspect percentage is above a threshold percentage (S417), the information resource is flagged as suspect (S419), thereby ending process 400 (S421). In the above example, since the first and second block-level element suspect percentages were both 89%, the information resource would be flagged as suspect if the threshold percentage was 89% or more. If the first and second block-level element suspect percentage is not above a threshold percentage (S417), process 400 ends (S421).

Although process 400 has been described as comparing the attributes of the first and second block-level elements with remaining block-level elements, the accuracy of the determination may also be increased by generating block-level element databases for the third through (N−1)^{th} block-level elements, and comparing attributes stored in these databases with remaining block-level elements. In this regard, suspect percentages may be generated for each of the third through (N−1)^{th} block-level elements, where the flagging of the information resource as suspect may be based upon the third through (N−1)^{th} block-level element suspect percentages as well.

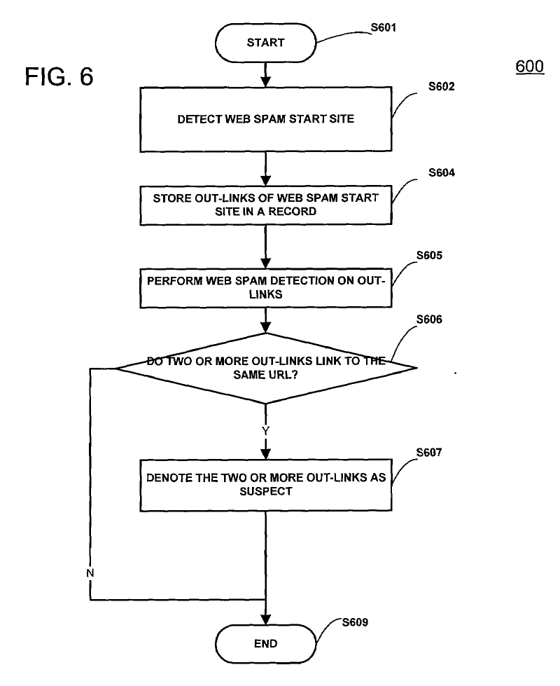

FIG. 6 depicts a process 600 for detecting a web spam farm. Web spammers may link multiple web spam sites, thereby creating a web spam farm in order to falsely build the page ranking and relevancy of a target site. Having identified a web spam start site, consecutive and branched trees of each target site can be mapped, effectuating the removal of web spam farms before further web spam sites are developed.

In further detail, process 600 begins (S601) when a web spam start site is detected (S602). Although the detection of web spam start sites is described above with reference to references S312 and S419 of FIGS. 3 and 4, above, other detection techniques may also be used. Out-links of the web spam start site are stored in a record associated with the web spam start site (S604). For example, in the web spam start site shown in FIG. 5, the out-linked URLS within block-level elements 504 and 512 are stored in a record.

Once the out-links are stored web spam detection may be performed on each of out-linked resources (S605). Web spam detection may occur using the approaches described above with regard to FIGS. 3 and 4, or some other web spam detection technique may be used. If two or more out-links link to the same URL (S606), the URLs associated with the two or more out-links are denoted as suspect (S607), and the process 600 ends (S609). If the URL of none of the out-links matches any other out-link, the process 600 ends (S609).

According to another general implementation, a computer program product, tangibly stored on a computer-readable medium, includes instructions for permitting a computer to perform a selecting step for selecting an information resource, the information resource including a plurality of block-level elements, a tokenizing step for tokenizing each of the block-level elements into attributes, and a generating step for generating a first block-level element database indexing the attributes of the first block-level element. Furthermore, the computer program product also includes instructions for permitting the computer to perform a comparing step for iteratively comparing the attributes indexed in the first block-level element database with the attributes of each remaining block-level element, a first flagging step for flagging remaining block-level elements as suspect based on a threshold number of attributes of the remaining block-level elements being present in the first block-level element database, and a second flagging step for flagging the information resource as suspect based on a threshold percentage of the remaining block-level elements being flagged as suspect.

According to another general implementation, a computer program product, tangibly stored on a computer-readable medium, includes instructions for permitting a computer to perform a selecting step for selecting an information resource, the information resource including first through N^{th} block-level elements, a tokenizing step for tokenizing each of the block-level elements into attributes, and a generating step for generating first and second block-level element databases indexing the attributes of the first and second block-level elements, respectively. Additionally, the computer program product also includes instructions for permitting the computer to perform a first comparing step for comparing the attributes indexed in the first block-level element database with the attributes of the second through the N^{th} block-level elements, a first flagging step for flagging the second through the N^{th} block-level element as suspect based on a threshold number of attributes the second through N^{th} block-level elements being present in the first block-level element database, and a first storing step for storing a first block-level element suspect percentage based upon a percentage of the second through N^{th} block-level elements which are flagged as suspect. Additionally, the computer program product includes instructions for permitting the computer to perform a second comparing step for comparing the attributes indexed in the second block element database with the attributes of the third through the N^{th} block-level elements, and a second flagging step for flagging the third through the N^{th} block-level element as suspect based on a threshold number of attributes of the third through N^{th} block-level elements being present in the second block-level element database. Moreover, the computer program product also includes instructions for permitting the computer to perform a second storing step for storing a second block-level element suspect percentage based on a percentage of the third through N^{th} block-level elements which are flagged as suspect, and a third flagging step for flagging the information resource as suspect based at least on the first and second block-level element suspect percentages and a threshold percentage.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
selecting an information resource, the information resource including a plurality of block-level elements;
tokenizing each of the block-level elements into attributes;
generating a first block-level element database indexing the attributes of the first block-level element;
iteratively comparing the attributes indexed in the first block-level element database with the attributes of each remaining block-level element;
flagging remaining block-level elements as suspect based on a threshold number of attributes of the remaining block-level elements being present in the first block-level element database; and
flagging the information resource as suspect based on a threshold percentage of the remaining block-level elements being flagged as suspect.

2. The method of claim 1, wherein the information resource is a World Wide Web (“WWW”) page.

3. The method of claim 1, wherein the information resource is identified by a unique Uniform Resource Locator (“URL”).

4. The method of claim 1, wherein the first block-level element is a title, a paragraph, a heading, a list, a table, an image, an information resource name, or metadata.

5. The method of claim 1, wherein the attribute is a word or a phrase.

6. The method of claim 1, further comprising deleting attributes from the first block-level element.

7. The method of claim 1, wherein the first block-level element database stores each attribute of the first block-level element and an indicator of a frequency of occurrence of the each attribute in the first block-level element.

8. The method of claim 7, further comprising deleting infrequently occurring attributes from the first block-level element database.

9. The method of claim 1, further comprising flagging links within the information resource as suspect links.

10. The method of claim 9, wherein links within the information resource are flagged as suspect links if uniform resource locators of two or more links point to a same target information resource.

11. A method comprising:
selecting an information resource, the information resource including first through N^{th} block-level elements;
tokenizing each of the block-level elements into attributes;
generating first and second block-level element databases indexing the attributes of the first and second block-level elements, respectively;
comparing the attributes indexed in the first block-level element database with the attributes of the second through the N^{th} block-level elements;
flagging the second through the N^{th} block-level element as suspect based on a threshold number of attributes the second through N^{th} block-level elements being present in the first block-level element database;
storing a first block-level element suspect percentage based upon a percentage of the second through N^{th} block-level elements which are flagged as suspect;
comparing the attributes indexed in the second block element database with the attributes of the third through the N^{th} block-level elements;
flagging the third through the N^{th} block-level element as suspect based on a threshold number of attributes of the third through N^{th} block-level elements being present in the second block-level element database;
storing a second block-level element suspect percentage based on a percentage of the third through N^{th} block-level elements which are flagged as suspect; and
flagging the information resource as suspect based at least on the first and second block-level element suspect percentages and a threshold percentage.

12. The method of claim 11, further comprising averaging at least the first and second block-level element suspect percentages.

13. A computer program product, tangibly stored on a computer-readable medium, the product comprising instructions for permitting a computer to perform:
a selecting step for selecting an information resource, the information resource including a plurality of block-level elements;
a tokenizing step for tokenizing each of the block-level elements into attributes;
a generating step for generating a first block-level element database indexing the attributes of the first block-level element;
a comparing step for iteratively comparing the attributes indexed in the first block-level element database with the attributes of each remaining block-level element;
a first flagging step for flagging remaining block-level elements as suspect based on a threshold number of attributes of the remaining block-level elements being present in the first block-level element database; and
a second flagging step for flagging the information resource as suspect based on a threshold percentage of the remaining block-level elements being flagged as suspect.

14. A computer program product, tangibly stored on a computer-readable medium, the product comprising instructions for permitting a computer to perform:
a selecting step for selecting an information resource, the information resource including first through N^{th} block-level elements;
a tokenizing step for tokenizing each of the block-level elements into attributes;
a generating step for generating first and second block-level element databases indexing the attributes of the first and second block-level elements, respectively;
a first comparing step for comparing the attributes indexed in the first block-level element database with the attributes of the second through the N^{th} block-level elements;
a first flagging step for flagging the second through the N^{th} block-level element as suspect based on a threshold number of attributes the second through N^{th} block-level elements being present in the first block-level element database;
a first storing step for storing a first block-level element suspect percentage based upon a percentage of the second through N^{th} block-level elements which are flagged as suspect;
a second comparing step for comparing the attributes indexed in the second block element database with the attributes of the third through the N^{th} block-level elements;
a second flagging step for flagging the third through the N^{th} block-level element as suspect based on a threshold number of attributes of the third through N^{th} block-level elements being present in the second block-level element database;
a second storing step for storing a second block-level element suspect percentage based on a percentage of the third through N^{th} block-level elements which are flagged as suspect; and
a third flagging step for flagging the information resource as suspect based at least on the first and second block-level element suspect percentages and a threshold percentage.

15. A device comprising:
a selecting module configured to select an information resource, the information resource including a plurality of block-level elements;
a processor configured to:
tokenize each of the block-level elements into attributes,
generate a first block-level element database indexing the attributes of the first block-level element,
iteratively compare the attributes indexed in the first block-level element database with the attributes of each remaining block-level element,
flag remaining block-level elements as suspect based on a threshold number of attributes of the remaining block-level elements being present in the first block-level element database, and
flag the information resource as suspect based on a threshold percentage of the remaining block-level elements being flagged as suspect; and
an output module configured to output the information resource based upon the information resource being flagged as suspect.
